(19) United States
(12) Patent Application Publication
(10) Pub. No.: US 2016/0355404 A1
(43) Pub. Date: Dec. 8, 2016

(54) PROCESS FOR CONVERTING OXYGENATED GAS INTO CARBON MONOXIDE

(71) Applicant: Schams A. Ahad, Vanderhoof (CA)

(72) Inventor: Schams A. Ahad, Vanderhoof (CA)

(21) Appl. No.: 15/175,016

(22) Filed: Jun. 6, 2016

Related U.S. Application Data
(60) Provisional application No. 62/171,101, filed on Jun. 4, 2015.

(51) Int. Cl. C01B 31/18

(52) U.S. Cl. CPC C01B 31/18

(57) ABSTRACT

A process for a gas phase thermochemical reduction of oxygenated gas, such as carbon dioxide (CO₂), by a solid activated charcoal to obtain premium grade, very high purity, carbon monoxide (CO) product. Whereby granular activated carbon (GAC) or powdered activated carbon (PAC) via a high temperature Reverse Boudouard Reduction Reaction (RBRR) using an oxygen exchange mechanism (OEM), is used to yield the carbon monoxide (CO) product in both a non-catalytic and a catalytic reactor.

### CROSS-REFERENCE TO RELATED APPLICATIONS

The present Utility patent application claims priority benefit of the U.S. provisional application for patent Ser. No. 62/171,101 entitled “PROCESS FOR CONVERTING OXYGENATED GAS INTO CARBON MONOXIDE”, filed on 4 Jun. 2015, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to thermal biomass conversion. More particularly, the invention relates to a process for converting oxygenated gas, e.g., carbon dioxide, into carbon monoxide using activated carbon.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. One may expect that carbon monoxide (CO) may be useful in some industry sectors such as, but not limited to, the liquid fuels refining sector, with particular emphasis on the manufacture of bio-diesel and as precursors in the manufacture of homologated alcohols, in the chemical manufacturing sector, etc. In addition, carbon monoxide (CO) may be used as substitute for hydrogen (H₂), where hydrogen is sourced from fossil fuel (as opposed to electrolysis of water (H₂O)). It is believed that the use of carbon monoxide (CO) rather than hydrogen (H₂) may be advantageous as carbon monoxide (CO) typically has lower reactivity than hydrogen (H₂) and is typically safer, and therefore lower in cost for transport and handling. It is contemplated that these industries may produce greenhouse gas emissions and other pollutants. An emission intensity is the average rate of emission of a given pollutant from a given source relative to the intensity of a specific activity, for example, without limitation, grams of carbon dioxide released per mega joule of energy produced. Emission intensities may also be used to compare the environmental impact of different fuels or activities. Herein, since carbon may be a common pollutant of producing carbon monoxide (CO), carbon intensity (CI) may refer to the relative amount of carbon released during an activity. The life cycle emission accounting of a particular activity may be designated by the term Carbon Intensity Index (CI Index). In some cases when the life-cycle carbon dioxide (CO₂) emission of a fuel or a reactive component that is used in manufacturing separate and distinct fuels, including without limitation carbon monoxide (CO), is lowered, that particular fuel or component may acquire the designation of fully or partially “renewable”. Due to growing interest in preserving the environment, one may expect that, liquid fuels or chemical components that are adjudicated with a lower CI Index or designated as fully or partially “renewable” may result in an increase in selling price for the fuel or component, which may provide an economic advantage.

By way of educational background, another aspect of the prior art generally useful to be aware of is that heretofore, carbon monoxide (CO) has typically been obtained from one of two groups of manufacturing processes. One of these processes may involve the electrolysis of carbon dioxide (CO₂) using electrodes made of a highly pure material such as, but not limited to, bismuth. It is believed that a significant amount of fossil fuel may be used in the refining process of the electrode material. Another process for obtaining carbon monoxide (CO) may involve the thermochemical reduction of carbon dioxide (CO₂) using components such as, but not limited to, high percentage carbon content coal, petroleum coke, metallurgical coke, graphitic carbon, low purity elemental carbon (soot) residues of combustion engines using fuels such as gasoline, diesel or natural gas, carbon black, biomass with co-products such as hydrogen (H₂), etc. The above reductants typically originate from fossilized carbon. Thus, when carbon monoxide (CO) is manufactured using the above mentioned fossil fuel sourced reactants, the future use of this specific component, carbon monoxide (CO), in the manufacture of higher homologated alcohols, alkenes, aldehydes, etc. typically may increase the CI Index for each of those products whether they are used directly as liquid fuels or as components for the manufacture of “greener” fuels such as “biodiesel.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram illustrating an exemplary process for Reverse Boudouard Reduction Reaction (RBRR) (the forward Boudouard reaction is named after its discovery and formulation by scientist Octave Leopold Boudouard) in a packed bed, multi-tube reactor 101 to yield industrial and process grade carbon monoxide (CO), in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forward most point of the upper or outsole and the rearward most point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and un-contradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a process for the gas phase thermochemical reduction of oxygenated gas, carbon dioxide (CO₂), by solid activated charcoal to obtain premium grade, very high purity, carbon monoxide (CO). In some embodiments this reduction reaction may be achieved via an oxygen exchange mechanism (OEM), as opposed to a carbon exchange mechanism. Some embodiments may involve the gas phase thermochemical reduction of oxygenated gas, carbon dioxide (CO₂), by granular activated carbon (GAC) or powdered activated carbon (PAC) via a high temperature Reverse Boudouard Reduction Reaction (RBRR) using an oxygen exchange mechanism (OEM) to yield carbon monoxide (CO) in both non-catalytic and catalytic reactors. In some embodiments, the reactant component, for example, without limitation, granular activated carbon (GAC) or powdered activated carbon (PAC), may be derived from renewable biomass charcoal. As these embodiments may use feed stocks (reactants) from renewable sources, the resulting downstream uses may yield lower Carbon Intensity (CI) indexes when life cycle carbon emissions are calculated by formal procedures that are adjudicated by qualified bodies such as, but not limited to, California Air Resources Board (CARB) or the US Environmental Protection Agency (EPA).

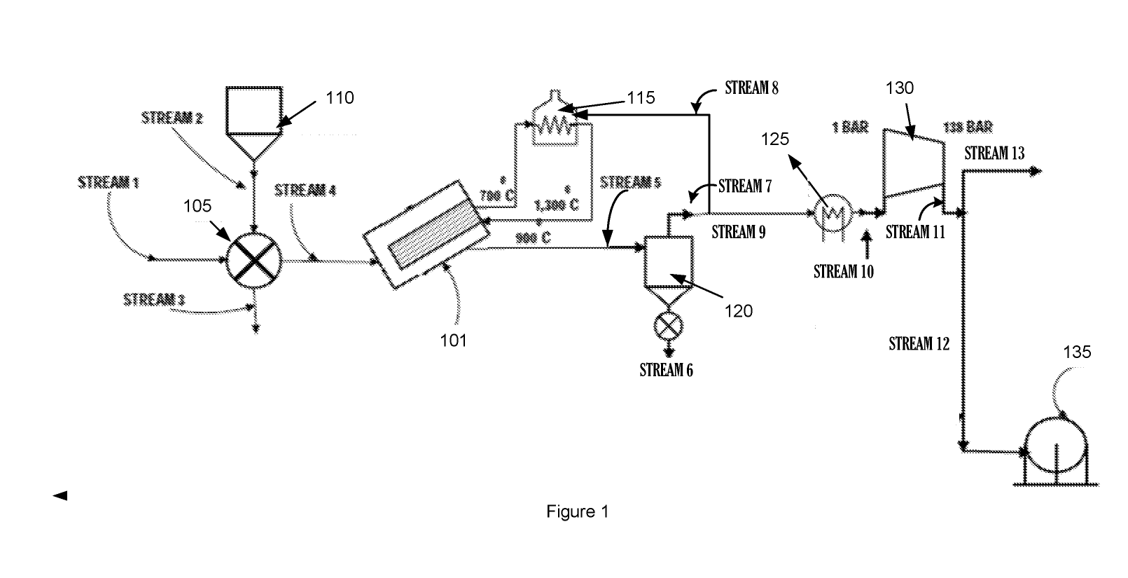

FIG. 1 is a schematic diagram illustrating an exemplary process for Reverse Boudouard Reduction Reaction (RBRR) in a packed bed, multi-tube reactor 101 to yield industrial and process grade carbon monoxide (CO), in accordance with an embodiment of the present invention. In the present embodiment, the process begins as Stream 1, typically comprising pure oxygenated gas, carbon dioxide (CO₂), is piped to a mixer 105. Those skilled in the art will readily recognize, in light of and in accordance with the teachings of the present invention, that various different phases and grades of CO₂ may be used including, without limitation, research grade 4.5 (liquid phase) CO₂ with a minimum purity of 99.998%, Coleman grade 4.0 (instrument grade) CO₂ with a minimum purity of 99.99%, medical grade 2.5 CO₂ with a minimum purity of 99.5%, standard grade 2.5 CO₂ with a minimum purity of 99.5%, etc. Furthermore, the CO₂ may be obtained from extant carbon capture sources such as, but not limited to, gaseous emission exhaust points at large industrial sites, with particular emphasis of legislatively mandated flue gas carbon dioxide (CO₂) segregation systems for fossil (coal, oil, natural gas) fuel based electrical power generation sites. Other sources of carbon dioxide (CO₂) that in the near future may be mandated to segregate carbon dioxide (CO₂) from their gaseous emission exhaust streams, include crude oil refineries, natural gas compression, separation and refining plants, large scale extraction and refining processes that are used in oil sands synthetic crude oil production and shale gas processing, fossil (coal, oil, natural gas) fuel heating, ventilating and air-conditioning (HVAC) plants, combustion processes such as refining of ultra-pure silicon, ultra-pure calcium carbonate (slaked lime and lime), cement manufacture, gypsum manufacturing, synthetic rubber and tire manufacturing, metals refining including, but not limited, to iron and steel, copper, nickel, manganese, molybdenum, uranium processing, and rare earth metals refining, forest products including plywood manufacturing, wood composite board manufacturing, and pulp and paper manufacturing. In mixer 105, the CO₂ may be mixed with activated carbon, which may be released as stream 2 from a storage bin 110. It is contemplated that the activated carbon may be in the form of granular activated carbon (GAC), powdered activated carbon (PAC), a mixture of both GAC and PAC, or other suitable reactants such as, but not limited to, renewable biomass activated charcoal. For example, without limitation, one possible source of activated carbon may be grade MWV SA-1500 PAC (MVA is an abbreviation for Mead West Vaco, the manufacturer), which is a high-activity Powdered Activated Charcoal with an extremely high surface area and a large number of pores in the meso-pore range “medium” (20 Å-50 Å, or 2-5 nm). The surface area specification is arrived using BET test methods (absorption porosity testing methodology pioneered by Messrs. Brunauer, Emmett and Teller) with an actual surface area ranging 1200 to 1400 m2/g. In some applications, the specification of the activated carbon may meet the food-grade quality of activated charcoal as defined in the current edition of the Food Chemicals Codex and/or may be Certified NSF/ANSI Standard 61. In the present embodiment, the reaction between the carbon dioxide (CO₂) and activated carbon may be achieved with or without a catalyst. While the RB reaction is entirely possible without catalyst, there is a possible embodiment of this patent which includes a catalyst. The possible uses of the catalyst is aimed at maintaining high reactivity of the reactants such that the carbon monoxide (CO) product dominates the product stream, while at the same time lowering the temperature of the reaction thereby decreasing the amount of energy used to complete this reaction and consequently lower the cost of operating this particular process. It is calculated that at that lower temperature there is initiated enhanced reactivity from inter-action of the carbon dioxide (CO₂) with the ready availability of reaction sites that are available electron-hole pairs that are present at the high porosity, activated carbon surface. When the catalyst is needed to assist in this thermal reaction, it is expected to be added in the RBRR reactor vessel, unit 101. One embodiment of this patent has the catalyst can be packed in tubes which are heated, externally by gases from the high temperature furnace. The reactants are passed through the tubes that are packed with the selected catalyst. The catalyst is expected to be of the magnesium-nickel-iron combination or alternatively, cobalt-magnesium-nickel combination. In another embodiment a specific catalyst combination of the above with molybdenum may also be considered as suitable, alternative catalyst. The CO₂ and activated carbon may be mixed in mixer 105 at atmospheric pressure and ambient temperature and then piped, as feed stock, stream 4, to Reverse Boudouard Reduction reactor (RBRR) unit 101. Stream 3 may be included in some embodiments as an emergency reactant disposal stream. The reactant disposal stream is to allow safe process operating conditions to be resumed, after possible RBRR reactor 101 encounters process upsets and/or process discontinuities.

In the present embodiment, RBRR 101 may be heated by a high temperature furnace 115 which has been specifically designed to operate at temperature range of between 1400° C. and 1500° C. In order that the carbon monoxide (CO) product may achieve lower carbon intensity (CI) index, the novel design of this particular furnace allows for heat from zero non-renewable sources of carbon. There are three (3) sources of heat for this high temperature furnace, unit 115. Two of the three sources are combustion process. The third source is process plant heat recovery from heat exchanger unit 125. The first of the two combustion process is the use of steel forge grade renewable charcoal as the main solid fuel for the high temperature furnace, unit 115. The second of the two combustion processes uses a small portion of the product, carbon monoxide (CO), as fuel for the high temperature furnace, unit 115. The three sources of heat can, typically, enable RBRR unit 101 to operate at temperatures above 700° C. and pressures of about 1 bar. If the reaction is to proceed without catalyst, then there is a preferred temperature range above 700° C. and below 900° C. In order to decrease energy consumption, catalyst may be used. In this case, depending on the catalyst, temperature ranges can be as low as 400° C. The “swing” between one reaction scenario (that is, without catalyst) and the other scenario (that is, with catalyst) is determined on economic grounds where cost of energy input and percent conversion is optimized against lower energy input plus additional cost of catalyst and consequent percent energy conversion. The high temperature Reverse Boudouard Reduction (RBR) reaction, which is both exergonic at designated temperatures and exothermic, may be performed in special purpose, dedicated, single stage, multi-tube, packed bed, high temperature RBR reactor, unit 101 to produce various grades of carbon monoxide (CO) on the surface of the activated carbon. Processing unit RBRR 101, described here as typical, may comprise a cylindrical, mild carbon steel shell approximately two meters in length and 0.5 meters in outside diameter with multiple stainless steel 304L tubes that may be packed with GAC or PAC. It is contemplated that RBRRs' in alternate embodiments may be implemented in various different shapes and sizes and may also be made with a multiplicity of suitable materials including, without limitation, various different metals, ceramic materials, composite materials, etc. In practice, RBRR unit 101, may be installed in the battery limits of a chemical process plant. The function of the packed bed is to allow reactants to inter-act with one another, such as what can achieved by either packing reactants only, or reactants plus designated catalyst, into reactor tubes that would be heated externally to achieve the high temperature necessary for the reaction to proceed to the point where carbon monoxide (CO) is dominant in the product stream. By “single stage”, is meant that the product stream is recycled, as often as necessary, through the RB reactor, until product specification is achieved. An alternative embodiment of this patent is envisaged where the carbon monoxide (CO) conversion process is achieved through processing in multistage reactors with distinct and separate “polishing” type catalysts, in each one of the multi-stage reactors that increase the concentration of the desired carbon monoxide (CO).

The Boudouard Reaction, according to one source is “the disproportionation of two molecules of carbon monoxide (CO) into carbon dioxide (CO₂) and graphite (carbon)”, and may be illustrated by the following formula: 2 CO═CO₂+C where ΔH=172 kJ/mol, 298° K. In the present embodiment, the reaction mechanism may be defined as the oxygen exchange mechanism (OEM), alternatively known as the Ergun Mechanism. The solid active carbon (GAC or PAC) is typically present to provide “free” sites (see explanation below) on its surface for the disassociation reaction of carbon dioxide (CO₂) to take place via the oxygen exchange mechanism. When OEM is the dominant reaction mechanism, the reactant carbon surface, here supplied by GAC, PAC or activated charcoal, may provide active sites only and typically only takes part minimally in the reduction of carbon dioxide (CO₂). Throughout the reaction there is typically minimal change in the amount of carbon reductant from solid to gas phase. As opposed to a carbon exchange mechanism, in which the solid carbon is typically consumed as part of the reduction reaction. Therefore, one may expect that the carbon reductant may have an extended period of reactivity (long reactant life). Usually, activated charcoal such as, but not limited to, GAC or PAC may comprise a large surface area (approx. 1,500 m2/g, measured as ASTM BET), a micro-pore structure with associated large pore volume, a high degree of surface reactivity, and low density. It is believed that the large surface area of the active carbon may be able to overcome kinetic barrier by providing a greater reaction contact area, resulting in more reaction sites or “free” sites between the solid activated carbon and the gaseous carbon dioxide (CO₂). The “kinetic barrier” is the lack of electron-hole pairs, or reactivity sites on the solid activated carbon surface until high temperature “expands” the inherent porosity of the surface. In addition to the kinetic barrier referred to earlier, there is a specific thermodynamic energy barrier for the reaction to reach equilibrium in favor of the desired product, carbon monoxide (CO).

Overcoming the thermodynamic barrier. Using Ellingham diagrams, which plot Gibbs Free Energy change (ΔG), it can be calculated that high temperature tends to favor the Reverse Boudouard Reaction and stable formation of carbon monoxide (CO), by reduction of oxygenated gas, carbon dioxide (CO₂). Here, the Gibbs Free Energy, ΔG, which typically should be largely negative for the reaction to overcome the thermodynamic energy barrier and rapidly achieve thermodynamic equilibrium, may be defined as follows: ΔG=ΔH−TΔS, Where enthalpy, ΔH=172 kJ/mol, 2980K. This large positive enthalpy is the thermodynamic energy barrier. However this thermodynamic barrier can be overcome and the resultant Gibbs Free Energy term, ΔG can yield the desired large negative amount only if the second term of the above equation is large. For the reduction of carbon dioxide, via “free” sites available on surface of carbon which is in a solid state, the formation of carbon monoxide (CO) has been defined as a two (2) stage process by Ergun as follows:

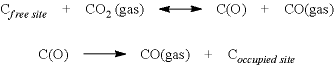

The above two stage reaction may demonstrate that an increase in number of moles of gas on the product side may lead to a positive ΔS and a negative slope. The larger readings for temperature, T, typically makes the product, −TΔS, to be largely negative. Consequently, the summation ΔG, according to above equation, becomes largely negative, and the reaction may reach the desired equilibrium. One reference has explained this discovery of Boudouard, as follows: “While the formation enthalpy of carbon dioxide (CO₂) is higher than that of carbon monoxide (CO), the formation entropy is much lower. Consequently, the standard free energy of formation of carbon dioxide (CO₂) from its component elements is almost constant and independent of temperature, while the free energy of formation of carbon monoxide (CO) decreases (becomes more negative) with temperature.” This particular phenomena—the deceasing Gibbs free energy of formation of carbon monoxide (CO) with temperature, is most desirable in breaking the thermodynamic energy barrier, thus allowing for the rapid formation of carbon monoxide (CO).

Referring again to FIG. 1, once the Reverse Boudouard Reaction is completed in RBRR unit 101, the carbon monoxide (CO) product, stream 5, may be filtered in a high temperature bag house 120 to remove any entrained activated carbon particles. The captured activated charcoal dust particles are disposed to sanitary landfill through stream 6. The filtered product, stream 7, may then be split into streams 8 and 9. Stream 8 is conveyed back, through suitable valving and metering, to the high temperature charcoal furnace unit 115 as one of two (2) fuels used in combustion processes that generate the required high temperature of 1400° C. as the steady state operating condition for that unit. Stream 9 is directed to a heat exchanger 125 to cool the product to approximately 50° C. In this embodiment, it is contemplated that the heat exchanger will have a heat recovery equipment package that will convey the heat recovered, most likely as low boiling point organic fluid, a typical example the family of such organic fluids known in heat recovery and process heating industry by the trade marked name of Dowtherm. The cooled product, stream 10, may be put through a compressor, unit 130. The product is compressed for ease of storage The compressed carbon dioxide (CO) product, stream 11, subsequent to an emergency vent stream 13, may be piped, as stream 12 into a product storage tank 135. The product storage tank, unit 135 has, as part of compliance with the appropriate codes used to certify pressure vessel safety, mandated safety vent. Stream 13 is an emergency product vent that is used to purge process of any off-specification product that can be caused by process upsets, discontinuities or failure to meet design operating conditions, for a variety of reasons, some planned and some, unplanned.

In the present embodiment, the carbon monoxide (CO) produced may be used as renewable fuel with almost the same heating value as hydrogen (H₂), 12.61MJ/m3 for carbon monoxide (CO) and 12.75MJ/m3 for hydrogen (H₂). The term “renewable” here is defined as any fuel derived from anthropogenic carbon dioxide (CO₂). In addition, the “renewable” nature of the carbon monoxide (CO) product, is further enhanced by zero use of any non-renewable fossil fuel in obtaining the high temperature necessary, from furnace, unit 115, that provides the 700° C. operating condition (when no catalyst is used in the RBR process) for the RBR reactor, unit 101. This product may be substituted for hydrogen (H₂), in virtually any application where hydrogen (H₂) is used as fuel in combustion engines for example, without limitation, in transport, electrical power generation, HVAC, and other fuel cell applications. Moreover, the CO₂ may typically have a calculated low carbon intensity (CI) index number. In addition, the renewable carbon monoxide (CO) may be able to transfer (pass through) its designation of “renewable” to products produced when the carbon monoxide (CO) is used as reactant in synthesis of chemical components and final products, in downstream chemical processes, operations, fuels, chemical products or components. As this particular manufacturing process for carbon monoxide (CO) uses feed stocks (reactants) from renewable sources, the resulting downstream uses may also yield a lower Carbon Intensity (CI) index when life cycle carbon emissions are calculated by formal procedures that are adjudication by qualified bodies. It is contemplated that, liquid fuels or chemical components that are adjudicated with lower CI Index may command premium prices in many industry sectors because they may be able to acquire the designation of “green” or “renewable” fuel.

This particular product, carbon monoxide (CO), obtained specifically by using solid granular or powdered activated carbon (GAC or PAC), as a reductant, may have particularly desirable applications in various industry sectors including, without limitation, the liquid fuels refining sector, with particular emphasis on the manufacture of bio-diesel and as precursors in manufacture of homologated alcohols, in industry sectors where CO may be used as a substitute for hydrogen (H₂), etc. Those skilled in the art will readily recognize, in light of and in accordance with the teachings of the present invention, that a multiplicity of suitable processes that may use or incorporate this particular innovation; that is, the manufacture of carbon monoxide (CO) from anthropogenic carbon dioxide (CO₂) by reacting aforesaid component with activated charcoal that is obtained from renewable sources, with the product carbon monoxide (CO) having the key property of low carbon intensity (CI) index not only because the two reacting components are, in and of themselves, considered renewable (any process that uses anthropogenic carbon dioxide (CO₂) is considered renewable under the protocols authorized by UNFCCC (United Nations Framework Convention on Climate Change) and approved methodologies set out by the UNFCCC implementation organization, the Clean Development Mechanism (CDM) based in Bonn, Germany) but significantly, that the main source of process heat supplied by high temperature furnace, a process unit integral to this innovation, is fueled by zero non-renewable sources; for example, without limitation, the manufacture of alcohols including without limitation methanol and ethanol, the manufacture of higher alcohols such as, but not limited to, butanol through homologation, the manufacture of alkenes such as ethylene used in the manufacture of plastics and building insulation and butylene used in the manufacturing butyl rubber (synthetic rubber), the manufacture of aldehydes such as, but not limited to, formaldehydes used in the food industry, the manufacture of MTBE (methyltetrabutylether), which is a fuel octane enhancer, the manufacture of DME (dimethylether), which is a transport diesel substitute, etc.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112 (6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a process for converting oxygenated gas, e.g., carbon dioxide, into carbon monoxide using activated carbon according to the present invention will be apparent to those skilled in the art. Various aspects of the invention have been described above by way of illustration, and the specific embodiments disclosed are not intended to limit the invention to the particular forms disclosed. The particular implementation of the process for converting oxygenated gas, into carbon monoxide using activated carbon may vary depending upon the particular context or application. By way of example, and not limitation, the process described in the foregoing were principally directed to industrial applications; however, similar techniques may instead be applied to a multiplicity of suitable alternate applications such as, but not limited to, medical applications, farming applications, or scientific research applications, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A process comprising:
directing carbon dioxide into a mixer;
releasing an activated carbon from a storage bin for combining with said carbon dioxide, wherein said activated carbon comprises a biomass charcoal;
combining, with said mixer, said carbon dioxide with said activated carbon;
feed stocking said mixed activated carbon and carbon dioxide to a Reverse Boudouard Reduction reactor unit;
heating said Reverse Boudouard Reduction reactor unit containing said mixed activated carbon and carbon dioxide with a high temperature furnace to produce a carbon monoxide product, wherein a steel forge grade renewable charcoal fuel is configured to provide a first source of fuel for said high temperature furnace;
filtering said carbon monoxide product in a high temperature bag house, wherein said filtering is configured to remove at least a portion of entrained activated carbon particles, and wherein said carbon monoxide product is substantially a result of a Reverse Boudouard Reaction from said reactor unit;
splitting said filtered carbon monoxide product into a first carbon monoxide product stream and second carbon monoxide product stream;
conveying at least a portion of said first carbon monoxide product stream back to said high temperature furnace, wherein said first carbon monoxide product stream is configured to provide at least a portion of a second source of fuel for said high temperature furnace;
directing a substantial portion of said second carbon monoxide product stream to a heat exchanger, said heat exchanger being configured to be operable for cooling said second carbon monoxide product stream.

2. The process of claim 1, further comprising compressing said cooled first carbon monoxide product stream in a compressor unit.

3. The process of claim 2, further comprising piping said cooled and compressed first carbon monoxide product stream to a product storage tank.

4. The process of claim 3, further comprising purging an off-specification carbon monoxide product to an emergency product vent, wherein said off-specification carbon monoxide product is caused by at least one of, a process upset, a discontinuity and a failure to meet design operating condition.

5. The process of claim 1, further comprising disposing said entrained activated carbon particles into a sanitary landfill.

6. The process of claim 3, wherein said carbon monoxide product is configured to provide renewable fuel.

7. The process of claim 1, in which said activated carbon comprising, at least one of, a granular activated carbon (GAC), a powdered activated carbon (PAC), and a mixture of both GAC and PAC.

8. The process of claim 1, further comprising adding a catalyst in said Reverse Boudouard Reaction reactor unit, wherein said catalyst is configured to maintain a high reactivity of reactants such that said carbon monoxide product dominates a product stream, and wherein said catalyst is further configure to lower a temperature of said reaction thereby decreasing the amount of energy used to complete said reaction and consequently lower an operating cost of said process.

9. The process of claim 1, further comprising providing heat to said high temperature furnace with steel forge grade renewable charcoal fuel.

10. A system comprising:
means for mixing an amount of carbon dioxide with an amount of activated carbon;
means for heating a Reverse Boudouard Reduction reactor unit containing said mixed activated carbon and carbon dioxide to produce a carbon dioxide product, wherein said heating means is configured to operate with renewable fuel;
means for filtering said carbon monoxide, wherein said filtering means is configured to remove entrained activated carbon particles, and wherein said carbon monoxide product is a result of a Reverse Boudouard Reaction from said reactor unit;
means for splitting said filtered carbon monoxide product into a first carbon monoxide product stream and second carbon monoxide product stream;
means for conveying said first carbon monoxide product stream back to said high temperature furnace;
means for cooling said second carbon monoxide product stream;
means for directing said second carbon monoxide product stream to said cooling means.

11. The process of claim 10, further comprising means for compressing said cooled second carbon monoxide product stream.

12. The process of claim 11, further comprising means for piping said compressed carbon monoxide product to a product storage tank.

13. A process comprising:
directing an oxygenated gas into a mixer;
releasing an activated carbon from a storage bin;
mixing said oxygenated gas with said released activated carbon in said mixer;
feed stocking said mixed activated carbon and said oxygenated gas to a Reverse Boudouard Reduction reactor unit;
heating said Reverse Boudouard Reduction reactor unit containing said mixed activated carbon and said oxygenated gas with a high temperature furnace, in which said heating is configured to produce a reduced Oxide product, wherein a renewable charcoal fuel is configured to provide a first source of fuel for said high temperature furnace;
filtering said reduced Oxide product in a high temperature bag house, wherein said filtering is configured to remove entrained activated carbon particles, and
wherein said reduced Oxide product is a result of a Reverse Boudouard Reaction from said reactor unit;
splitting said filtered reduced Oxide product into a first reduced Oxide product stream and second reduced Oxide product stream;
conveying said first reduced Oxide product stream back to said high temperature furnace, wherein said first reduced Oxide product stream is configured as a second source of fuel for said high temperature furnace;
directing said at least a portion of second reduced Oxide product stream to a heat exchanger, wherein said heat exchanger is configure to cool said second reduced Oxide product.

14. The process of claim 13, wherein said oxygenated gas is carbon dioxide and said reduced Oxide is carbon monoxide.

15. The process of claim 14, further comprising compressing said second cooled second carbon monoxide product stream in a compressor unit.

16. The process of claim 15, further comprising piping said compressed second carbon monoxide product stream to a product storage tank.

17. The process of claim 16, further comprising purging an off-specification carbon monoxide product to an emergency product vent, wherein said off-specification carbon monoxide product is caused by, at least one of, a process upset, a discontinuity and a failure to meet design operating conditions.

18. The process of claim 14, further comprising disposing said entrained activated carbon particles.

19. The process of claim 14, in which said activated carbon comprising, at least one of, a granular activated carbon (GAC), a powdered activated carbon (PAC), and a mixture of both GAC and PAC.

20. The process of claim 14, further comprising adding a catalyst in said Reverse Boudouard Reaction reactor unit, wherein said catalyst is configured to maintain a high reactivity of reactants such that said carbon monoxide product dominates a product stream, and wherein said catalyst is further configured to lower a temperature of said reaction thereby decreasing the amount of energy used to complete said reaction and consequently lower an operating cost of said process.
